(19) United States
(12) Patent Application Publication
(10) Pub. No.: US 2013/0089225 A1
(43) Pub. Date: Apr. 11, 2013

(54) BINAURAL-RECORDING EARPHONE SET

(71) Applicant: Cheng-Ho Tsai, Taichung (TW)

(72) Inventor: Cheng-Ho Tsai, Taichung (TW)

(21) Appl. No.: 13/253,618

(22) Filed: Oct. 5, 2011

(51) Int. Cl. H04R 5/02

(52) U.S. Cl. 381/309

(57) ABSTRACT

A binaural-recording earphone set is provided. It comprises two speaker units and two microphone units, the two speaker units are inserted into the auditory canal of two ears respectively. The two microphone units are coupled on the two speaker units and can be dismounted. Under a recording mode, the microphone units can be dismounted from the speaker units, and replace the speaker units to be inserted into the auditory canal of the two ears to record external sound. Under a play mode, the speaker units are inserted back into the auditory canal of the two ears to playback the sound recorded previously.

### BACKGROUND OF THE INVENTION

1. Field of Invention

The present invention relates to a binaural-recording earphone set and more particularly to a binaural-recording earphone set which under a recording mode, microphone units can be detached from speaker units and replace the disposing locations of the speaker units.

2. Related Art

Because of the differences in the structures of earphone and speaker, the sound field effects for playing back music are different. Most earphones in the market today can not show natural sound field. It is because the music played back by the speakers has to go through air before entering into human ears, and the sound from the speakers is the same as various sound in the nature, which has to go through the auricles, earlaps, auditory canal and ear drums before being sensed by the brain nerves.

In the process of sound transmitting, sound waves are refracted, diffracted and inflected by the auricle, auditory canal, skull and shoulders which will affect the sound, it is known as the head-related transfer function (HRTF). Human brains can judge the direction and distance of the sound by experience, that is judging by the experience of affection of the head-related transfer function (HRTF). However, sound is sent by earphones directly into the ears, therefore, it is not affected by head-related transfer function (HRTF) and the direction and distance of the sound cannot be judged by human brains.

Currently, in order to solve the abovementioned problems, dummy heads with dual track recording method is used. Music recorded by using dummy heads being playback via earphones can produce full-sphere sound field effect which is even more lifelike than speakers. This sound recording method employs two micro-sized omnidirectional microphones placing inside the auditory canal (located closely to human ear drum) of a dummy head which is very similar to a real human head, in order to simulate the process of sound listened by human ears. The dummy head also has auricles, auditory canal, skull, hair and shoulders, even the skin and skull can be made of materials similar to human. In this way, the way human ears affected by head-related transfer function (HRTF) in listening to sound can be realistically simulated as much as possible.

The abovementioned dual track recording method is mostly used by recording professionals who put on a dummy head to proceed with recording. The music recorded is then played and listened by music appreciators. It is very inconvenient for users who want to have the sound field to be shown again by recording. Because of the multi-functional requirements of electronic products such as portable mobile phones or laptops, the functions of earphones to be used with these products are therefore needed to be enhanced.

### SUMMARY OF THE INVENTION

In view of the abovementioned problems, the present invention provides a binaural-recording earphone set. The microphone units of the earphone set can be detached from the speaker units. Under a recording mode, the microphone units are disposed at the best recording locations in order to provide the most realistically simulated head-related transfer function (HRTF), and the most natural sound field can be reappeared by playing via the speaker units.

In order to achieve the abovementioned objects, a binaural-recording earphone set of the present invention comprises two speaker units and two microphone units, the two speaker units are inserted into the auditory canal of two ears respectively in order to play music. The two microphone units are coupled on the two speaker units and can be dismounted. Under a recording mode, the microphone units can be dismounted from the speaker units, and replace the speaker units to be inserted into the auditory canal of the two ears to record external sound. Under a play mode, the speaker units are inserted back into the auditory canal of the two ears to playback the sound recorded previously.

A binaural-recording earphone set of the present invention employs a detachable design of the microphone units from the speaker units. Under a recording mode, the microphone units replace the speaker units to proceed with recording. It can ensure that the effects of head-related transfer function (HRTF) are not affected. Under a play mode, the most realistically simulated recorded sound is playback by the speaker units which are inserted back into the auditory canal.

### BRIEF DESCRIPTION OF THE DRAWINGS

FIG. 1 is an exploded view of a first embodiment of a binaural-recording earphone of the present invention;

FIG. 2 is an illustration of FIG. 1 of a binaural-recording earphone under a recording mode;

FIG. 3 is an exploded view of a second embodiment of a binaural-recording earphone of the present invention;

FIG. 4 is an illustration of FIG. 3 of a binaural-recording earphone under a recording mode; and

FIG. 5 is a schematic view of switching of operating modes of a binaural-recording earphone set of the present invention.

### DETAILED DESCRIPTION OF THE INVENTION

An embodiment of a binaural-recording earphone set of the present invention will become more fully understood by reference to the following detailed description thereof when read in conjunction with the attached drawings.

A binaural-recording earphone set of the present invention mainly comprises two speaker units and two microphone units. The two microphone units are coupled on the two speaker units and can be dismounted. For the sake of simplified drawings and convenience for descriptions, only a single ear is used in the drawings for the descriptions of the present invention; also, only a single speaker unit with a single microphone unit are used to describe the structural components and techniques characterized.

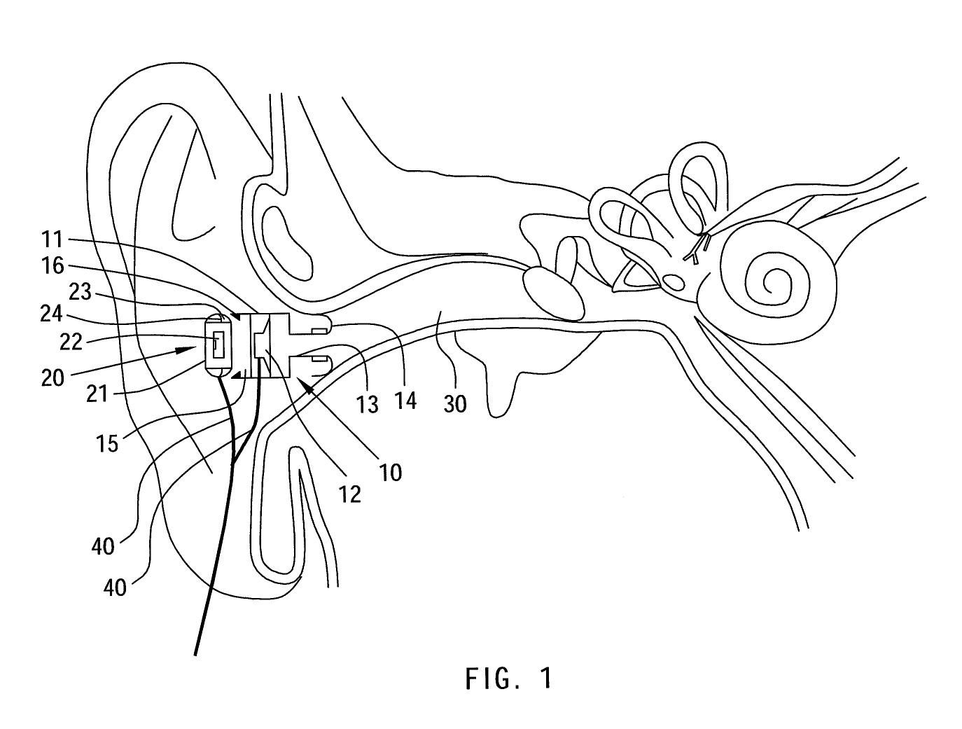

FIG. 1 shows an exploded view of a binaural-recording earphone of the present invention. It comprises a speaker unit 10 and a microphone unit 20. The speaker unit 10 is inserted into an auditory canal 30. The microphone unit 20 can be coupled on an outward-facing end of the speaker unit 10.

The speaker unit 10 comprises a body case 11 and a speaker 12, the speaker 12 is accommodated inside the body case 11. A sound tube 13 is extended from a front end of the body case 11. An earplug 14 is sleeved on the sound tube 13. A cavity 15 is extended from a rear end of the body case 11.

The microphone unit 20 comprises a body case 21 and a microphone 22, the microphone 22 is accommodated inside the body case 21. An earplug 23 is sleeved on the body case 21.

A fastener 16 is disposed inside the cavity 15 of the speaker unit 10. When the microphone unit 20 is inserted into the cavity 15, movement of the microphone unit 20 is limited by a fastening portion 24 of the earplug 23 and the fastener 16. The body case 11 of the speaker unit 10 is mostly in a round shape but not limited to, therefore, the fastener 16 can be in a ring shape, or a protrusion can be disposed on an upper end and a lower end of the cavity 15 respectively.

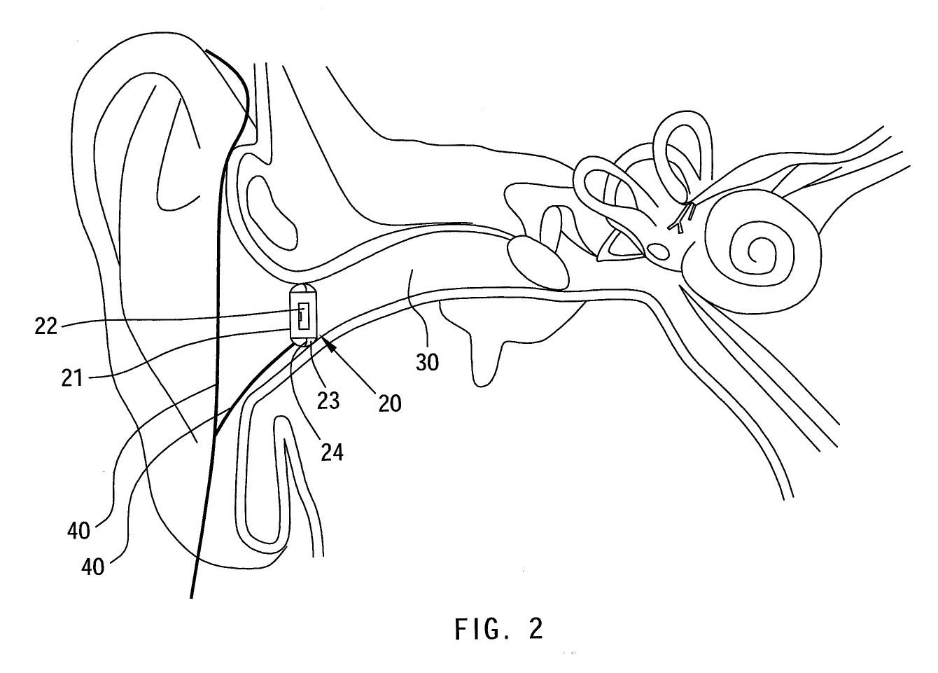

FIG. 2 shows an illustration of FIG. 1 of a binaural-recording earphone under a recording mode. When it is under the recording mode, users can detach the microphone unit 20 from the speaker unit 10 first, and take out the speaker unit 10 from the auditory canal 30 and hang it behind an ear, then insert the microphone unit 20 into the position where the speaker unit 10 was disposed before, the position is at an entrance of the auditory canal 30. Therefore, the microphone unit 20 is fixed at the entrance of the auditory canal 30 by the earplug 23.

The microphone unit 20 is used for recording external sound field, therefore a side of the microphone 22 for receiving sound is facing outward. As shown in FIG. 1, when the microphone unit 20 is coupled on the speaker unit 10, the side of the microphone 22 for receiving sound also faces outward. Under a noise elimination mode, the microphone unit 20 is used to receive a sound source signal from the surrounding, and an opposite surrounding sound source signal with a same frequency but an opposite phase is produced based on the sound source signal of the surrounding, the signal is then importing into the speaker unit 10 in order to eliminate the surrounding sound source.

Via a transmitting wire 40, the speaker unit 10 and the microphone unit 20 are electrically connected to an external electronic device such as a mobile phone or a computer, etc., and the electronic device is equipped with a digital signal processor for signal processing under the different modes mentioned above. The modes are switched by operating the device, or by an additional control box disposed on the transmitting wire 40.

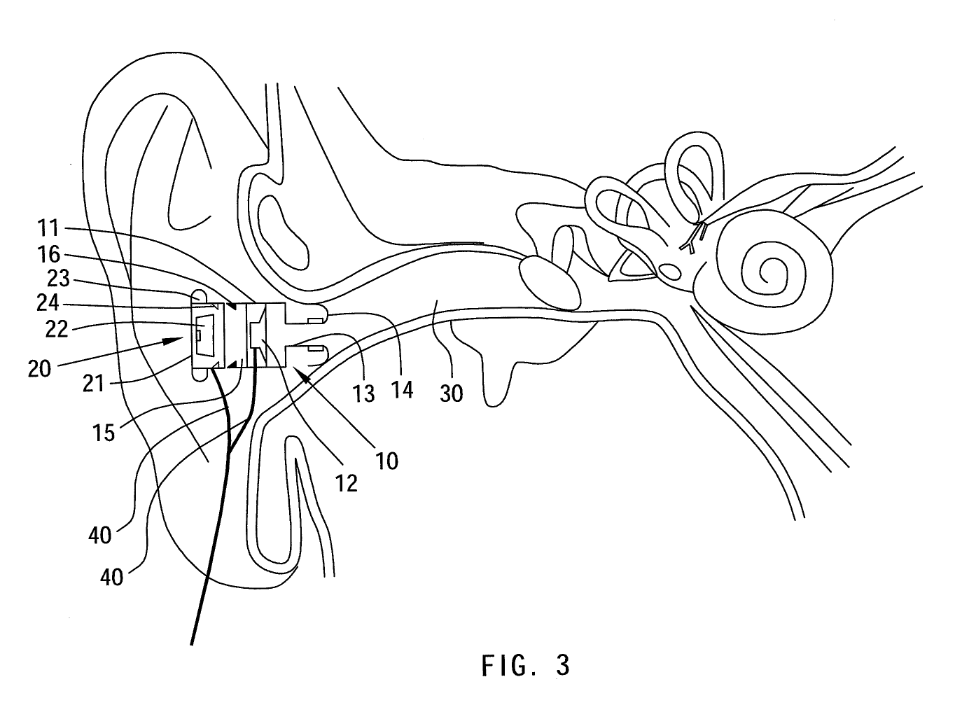

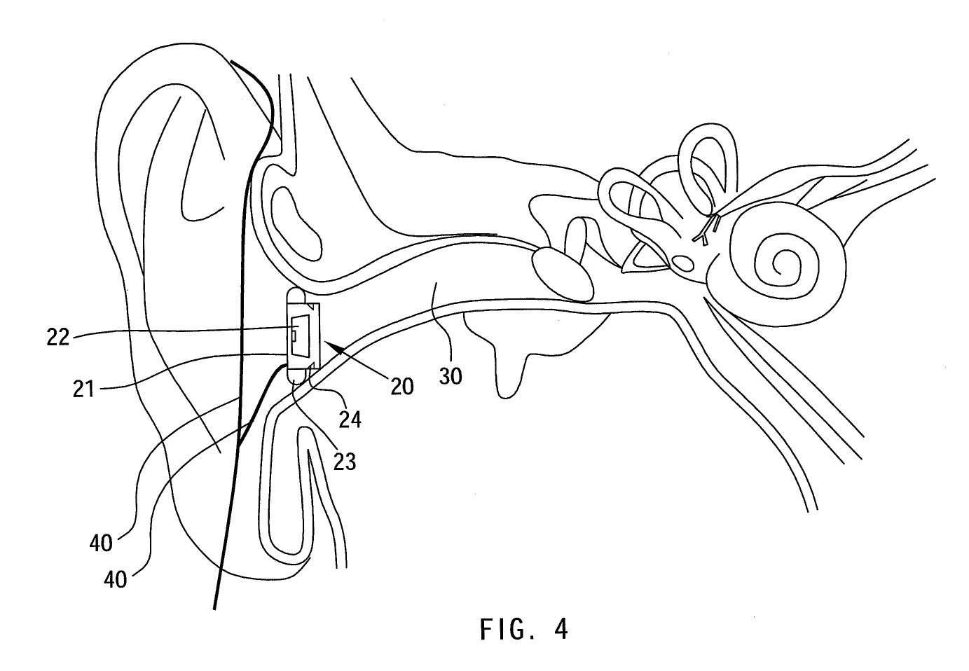

FIG. 3 is an exploded view of a second embodiment of a binaural-recording earphone of the present invention, and FIG. 4 is an illustration of FIG. 3 of a binaural-recording earphone under a recording mode. Referring to the drawings, the differences between the second embodiment and the first one lies in that: the earplug 23 of the microphone unit 20 is disposed on an end of the body case 21, and the fastening portion 24 is hollowly disposed on an external circumference of an exposed portion on another end of the body case 21, so that movement of the microphone unit 20 is limited by the fastening portion 24 and the fastener 16 of the speaker unit 10. The fastening portion 24 can be designed as a groove surrounding the body case 21, or as a groove disposing on an upper end and a lower end of the body case 21 respectively, in corresponding to the design of the fastener 16.

Furthermore, the second embodiment of an assembled binaural-recording earphone, the side of the microphone 22 for receiving sound faces outside of the auditory canal 30. Under a recording mode, the microphone unit 20 is inserted directly into the auditory canal 30, and is fixed at the entrance of the auditory canal 30 by the earplug 23.

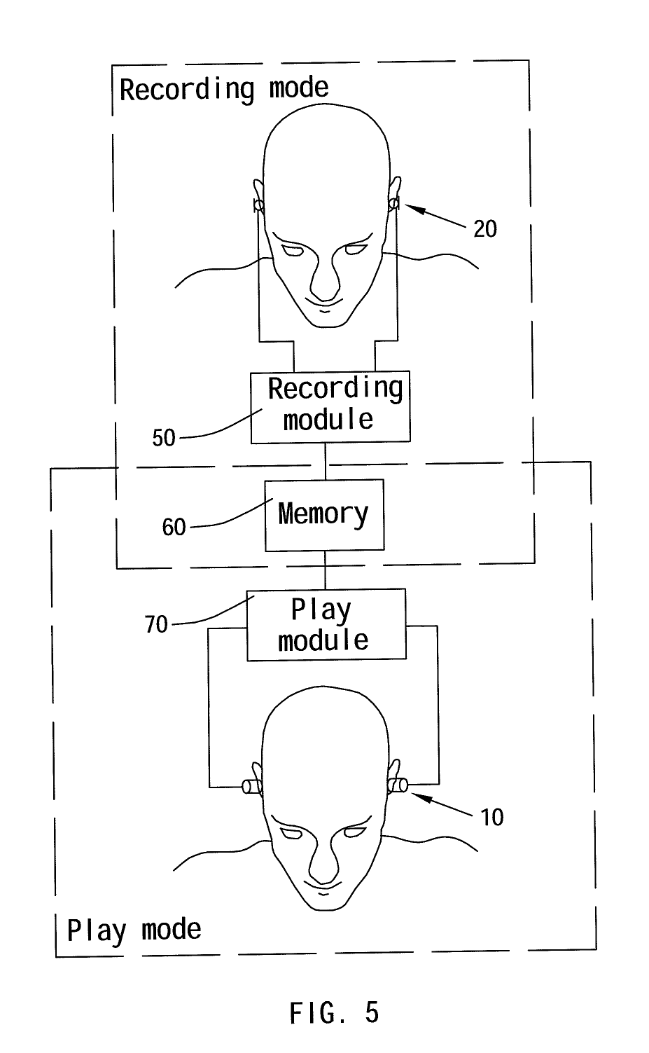

In addition, please refer to FIG. 5 which is a schematic view of switching of operating modes of a binaural-recording earphone set of the present invention. Because the microphone unit 20 and the speaker unit 10 can be detached from each other, thus under the recording mode, the microphone unit 20 can be inserted into the user's auditory canal as shown in FIG. 5. An audio signal can be converted from an analog signal into a digital signal by using a recording module 50, and the digital signal can be stored in a memory 60. As shown in FIG. 2 or 4, because the entrances of the auditory canal can be blocked by placing the microphone unit 20 at the entrances, thus sound can be recorded as if it is picked up by human ears at locations for receiving sound. Furthermore, when a binaural-recording earphone set of the present invention is operated under the play mode, the microphone unit 20 placed at the entrances of the auditory canal can be replaced with the speaker unit 10, and the digital audio signal which is recorded by the microphone unit 20 and stored in the memory 60, can be converted into an analog audio signal by a play module 70, then it can be played by the speaker unit 10 for the user to listen. Because the effects of head-related transfer function (HRTF) are not affected by the audio signal recorded previously, thus the sound playback by the speaker unit 10 is the same as if it is a recording of a three dimensional sound field at that time, and therefore it can provide the most realistically simulated effects of sound retrieval.

It is important to note that, besides the disclosed in-ear earphone, the present invention can also be applied in earplug earphones. Besides using the fastener 16 and the fastening portion 24 as a way of coupling, magnetic attraction can also be used for the coupling of the speaker unit 10 and the microphone unit 20.

To summarize the above, a binaural-recording earphone set of the present invention employs a detachable coupling design of the microphone units and the speaker units. Under a recording mode, the microphone units replace the speaker units at the entrances of the auditory canal to proceed with recording. By sealing the entrances of the auditory canal, it can ensure that the effects of head-related transfer function (HRTF) are not affected by the external recorded sound. Under a play mode, the external recorded sound is playback with the most realistically simulated sound field effects by the speaker units which are inserted back into the entrances of the auditory canal.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A binaural-recording earphone set comprising:
two speaker units inserted into the auditory canal of two ears respectively to play sound signals; and
two microphone units detachably coupled on said speaker units;
wherein, when said binaural-recording earphone set is under a recording mode, two of said microphone units are detached from two of said speaker units, and to replace said speaker units to be inserted inside the auditory canal of the pair of ears, two sides of said microphone units for receiving sound face outside the ears.

2. The binaural-recording earphone set as claimed in claim 1, wherein, under said recording mode, two of said microphone units are disposed at the entrances of the auditory canal of the pair of ears.

3. The binaural-recording earphone set as claimed in claim 1, wherein each of said speaker units comprises a body case to accommodate one of said speaker units.

4. The binaural-recording earphone set as claimed in claim 3, wherein a sound tube is extended from a front end of said body case, an earplug is sleeved on said sound induction tube.

5. The binaural-recording earphone set as claimed in claim 3, wherein a cavity is extended from a rear end of said body case for assembling said microphone unit.

6. The binaural-recording earphone set as claimed in claim 5, wherein a fastener is disposed on a circumference of said cavity for fastening said microphone unit.

7. The binaural-recording earphone set as claimed in claim 1, wherein each of said microphone units comprises a body case to accommodate one of said microphone units, and an earplug is sleeved on said body case.

8. The binaural-recording earphone set as claimed in claim 7, wherein said earplug seals the auditory canal.

9. The binaural-recording earphone set as claimed in claim 7, wherein said earplug is disposed on one end of said body case, and a fastening portion is disposed on another end of said body case for fastening said microphone unit with said speaker unit.

10. The binaural-recording earphone set as claimed in claim 7, wherein a fastening portion is disposed on said earplug for fastening said microphone unit with said speaker unit.

11. The binaural-recording earphone set as claimed in claim 1, wherein said microphone unit is magnetically attracted to said speaker unit.

12. The binaural-recording earphone set as claimed in claim 1, wherein, under a noise elimination mode, two of said microphone units are assembled on two of said speaker units, and two of said microphone units receive a surrounding sound source signal, and an opposite surrounding sound source signal is produced for two of said speaker units.
